(19) United States
(12) Patent Application Publication
(10) Pub. No.: US 2010/0024744 A1
(43) Pub. Date: Feb. 4, 2010

(54) DOG RESTRAINT ARRANGEMENT

(76) Inventor: Brent Marc Baillie, Toronto (CA)

Correspondence Address: Brent Marc Baillie, 17 Sudbury St., Unit 1705, Toronto, ON, M6J 3W6, CA

(21) Appl. No.: 12/512,533

(22) Filed: Jul. 30, 2009

(30) Foreign Application Priority Data
Aug. 1, 2008 (CA) 2,638,475

(51) Int. Cl. A01K 27/00; A01K 13/00; B68B 99/00

(52) U.S. Cl. 119/855; 119/856; 54/35; 119/858

(57) ABSTRACT

The pet restraint system sheaths a restraint strap between an outer waterproof layer and an inner breathable fabric layer. These layers are oversized relative to the strap and do not extend the entire length of the strap. This arrangement is advantageously used in a pet collar structure, or a pet restraint harness. It has particular application for a dog collar or a dog restraint harness.

### FIELD OF THE INVENTION

The present invention relates to a dog restraint arrangement, and in particular, to a system that reduces chafing and/or friction of the dog using the device. The dog restraint system has particular application with respect to pet collars and pet harnesses.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Many dogs, and in particular short haired dogs, have sensitive skin and a dog collar or dog harness often causes chafing and/or skin irritation due to friction, heat retention and moisture retention. Dog collars have provided some adaptation to reduce the friction associated with straps of these devices, and typically include a fleece-type inner surface adhered to a nylon or leather outer surface. The outer surface provides the tensile strength necessary for restraining of the dog, while the inner layer partially reduces friction. Although these collars are superior to collars without such a friction reducing material, the collars can still cause skin irritation.

There remains a need to provide a functional yet decorative collar that overcomes a number of disadvantages of the prior art.

### SUMMARY OF THE INVENTION

A pet restraint arrangement according to the present invention is adapted to be worn by a pet and comprises at least one elongate strap of a material to provide sufficient tensile strength to restrain the pet and be secured about the neck or chest of the pet. The elongate strap at an intermediate portion thereof is secured between an oversized waterproof layer located on one side of said elongate strap and an oversized breathable fabric layer provided on an opposite side of the elongate strap. The breathable fabric covers the waterproof layer and is peripherally attached to the waterproof layer on opposite sides of the elongate strap.

According to an aspect of the invention, the waterproof layer and the breathable fabric layer are attached to the at least one strap at either end with the strap within the layers being free to move between the layers. Preferably, the waterproof layer is of a latex material.

In an aspect of the invention, the latex material is sewn to the breathable layer to thereby attach the breathable layer to the latex layer.

In a related aspect of the invention, the latex layer has an engrave peripheral recess in a top face thereof and a series of stitches are located in the recess and secure the latex layer to the breathable fabric layer.

In a preferred aspect of the invention, the restraint arrangement is a dog collar with the breathable fabric layer providing a friction reducing surface between the elongate strap and the pet. Preferably, the dog collar is a martingale style dog collar.

In a further aspect of the invention, the waterproof layer and the breathable layer form a sheath about the elongate strap. The elongate strap beyond the sheath includes at either end thereof, a slip ring with a further restraint strap passing through both slip rings and secured to form a closed loop. Preferably, the further restraint strap includes a fixed securement ring on an outer portion of the closed loop and intermediary the slip rings.

In a different aspect of the invention, the pet restraint arrangement is a pet harness.

In a preferred aspect of the invention, the elongate strap of the pet harness is a chest strap and the waterproof layer and the fabric layer extend to and are connected to a rear body strap of the harness.

In a preferred aspect of the invention, the dog collar or dog harness includes in the waterproof material phosphorescent particles for glowing in the dark when appropriately activated.

### BRIEF DESCRIPTIONS OF THE DRAWINGS

Preferred embodiments of the invention are shown in the drawings, wherein:

FIG. 1 is a perspective view of a martingale-type dog collar of the present invention;

FIG. 2 is a partial front perspective view showing the components of the martingale collar;

FIG. 3 is a partial sectional view through the collar showing particular cooperation of two opposed layers partially sheathing a restraint strap;

FIG. 4 is a perspective view of a pet restraint harness;

FIG. 5 is a top view of the pet restraint harness of FIG. 4 in a flat orientation; and

FIG. 6 is a partial sectional view showing details of one of the straps of the pet restraint harness.

### DETAILED DESCRIPTION OF THE INVENTION

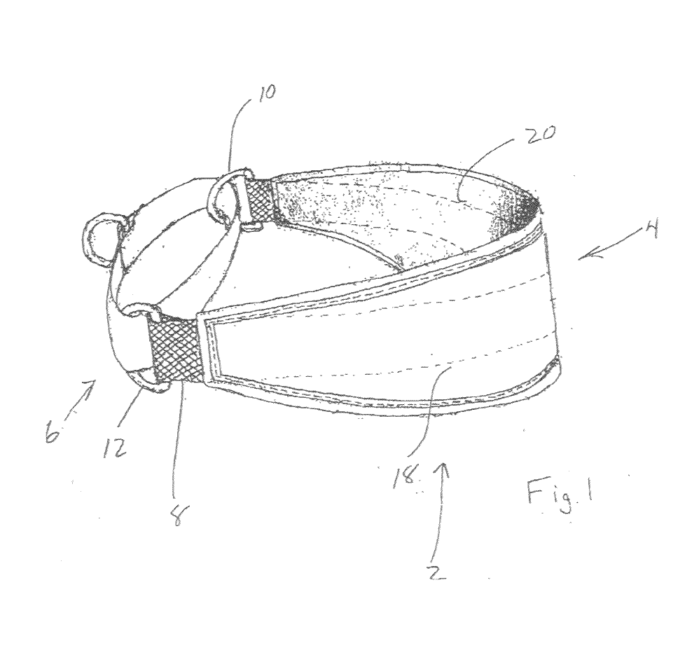

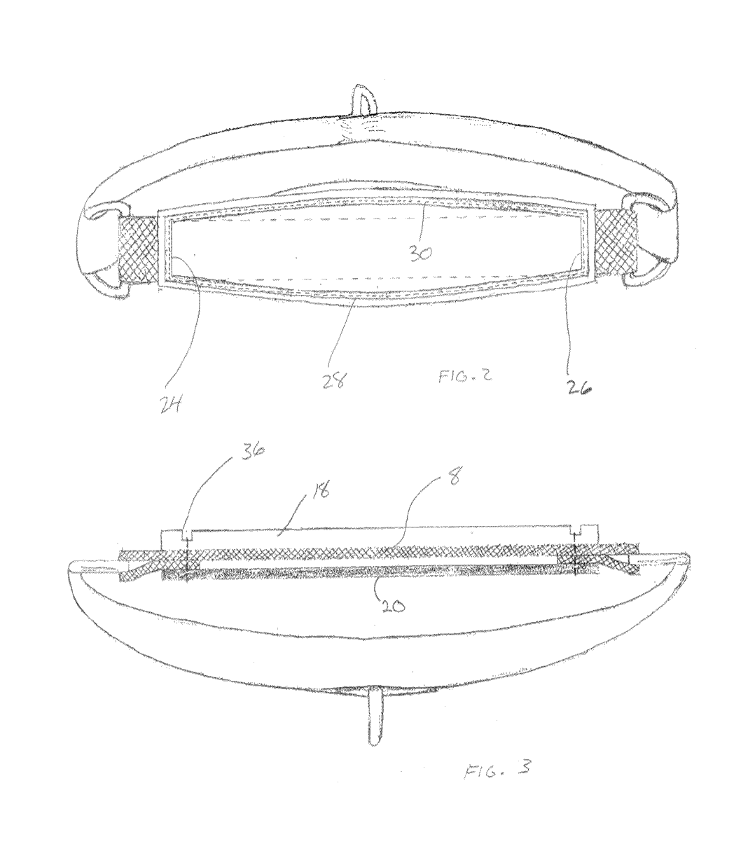

The martingale-style dog collar 2 shown in FIGS. 1 through 3 includes a composite restraining strap assembly 4. The assembly includes an actuating loop strap 6 fastened to a nylon restraining strap 8. D-loops 10 and 12 are provided at either end of the restraining strap 8.

A waterproof outer layer 18 cooperates with a breathable interior layer 20 which are each oversized relative to the restraining strap 8 and form a sheath about a partial length above the restraining strap 8. The layers 18 and 20 are secured by stitch attachments 24 and 26 to the nylon restraining strap at opposed ends of the waterproof outer layer 18 and the breathable interior layer 20. The portion of the restraining strap within and between the ends of the two layers is freely floating with the two layers. The two layers are secured to each other at the peripheral stitch attachments 28 and 30.

FIGS. 1, 2 and 3 show the restraining strap located between the layers in dashed lines for better understanding.

With this arrangement, the waterproof outer layer 18 and breathable interior layer 20 provide a wide area with the breathable interior layer 20 in contact with the pet. The strap within the sheath formed by these layers floats or moves relative to the layers, and the friction forces exerted against the dog's coat are reduced. The outer waterproof layer helps to reduce the possibility and/or the frequency of the nylon strap becoming wet. The breathable interior layer 20 helps to reduce heat buildup on the interior of the strap, and also provides a wider area for any moisture to effectively evaporate.

A dog restricted with this martingale-style collar has the nylon restraining strap 8 effectively spaced from the coat of the dog beneath the head of the dog. The nylon restraining strap 8 allows the owner to exert a significant force on the dog while limiting this force and avoiding the full extent of a choke-type collar.

In a preferred embodiment of the invention, the waterproof outer layer is made of a rubber material, preferably a latex rubber, and includes a recess 36 provided in the waterproof layer 18 as shown in FIG. 3. This recess 36 simplifies the stitching of the outer waterproof layer and the breathable interior layer 20 to the restraining strap 18 at the stitch securement positions 24 and 26. The recess 36 also extends about the periphery of the waterproof outer layer and accommodates the peripheral stitch attachment points indicated as 28 and 30.

The outer waterproof layer can be made in various colours and be of various materials to effectively reduce the moisture content that the restraining strap 8 would incur if not protected by this layer. As can be appreciated, the normal activities of a dog expose the collar to moisture. This outer protective waterproof layer helps to reduce the friction and discomfort that may occur as the restraining strap 8 is less likely to be wet.

When the outer waterproof layer is made of a latex or other rubber-type material, it can be cast or stamped, and can also include phosphorescent particles to render this layer a glow in the dark-type layer when appropriately activated by light. In this way, the collar can also act as a safety surface for the dog if the owner appropriately activates this layer when the dog is out at night.

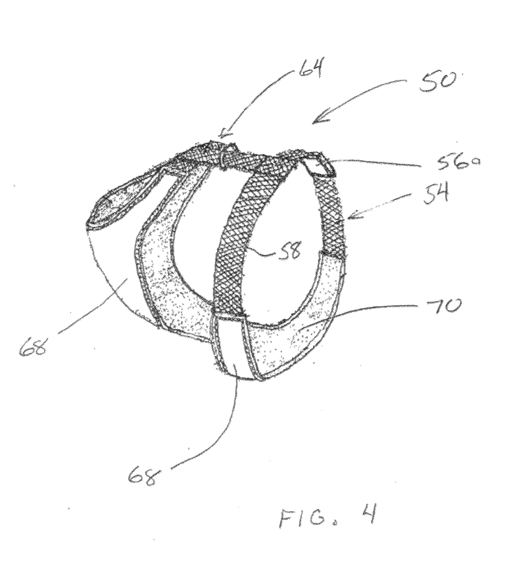

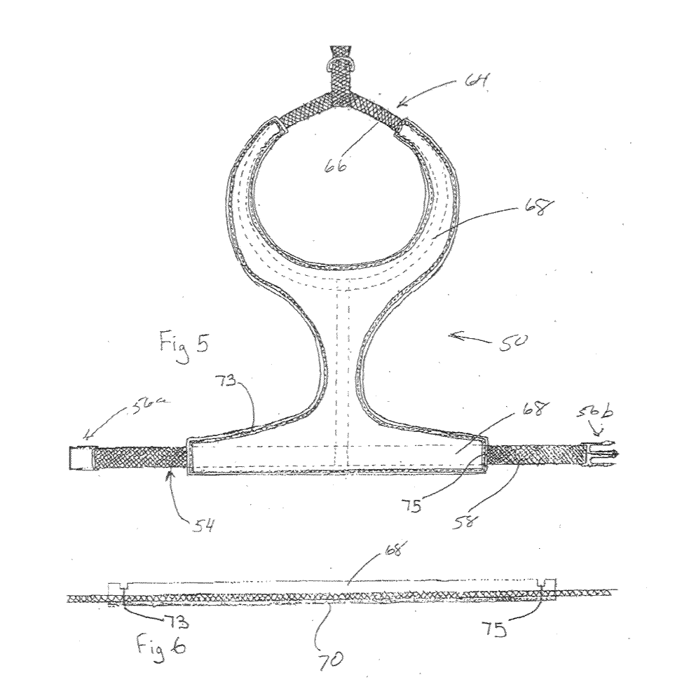

An alternate embodiment of the invention is shown in FIGS. 4 through 6 where the pet restraint arrangement is in the form of a pet harness. The pet harness 50 includes a composite restraining strap assembly 54 having a two-piece adjustable clip (56a, 56b) for securing of the harness 50 about the dog. A nylon restraining strap 58 is provided as part of the device, and is partially sheathed by the waterproof outer layer 68 and the inner breathable layer 70. The composite restraining strap assembly is typically secured around the body of the dog. In the maimer described with respect to FIGS. 1 through 3, these layers provide the protection against inadvertent moisture as well as reducing friction that may lead to chafing of the dog's coat and skin.

A similar composite strap assembly 64 is provided for securement about the neck of the dog. The composite strap assembly includes the restraining strap 66 partially sheathed by the waterproof outer layer 68 and the breathable layer 70. These layers are secured in the manner as described with respect to the dog collar of FIGS. 1 through 3.

As previously described, it is desirable that the waterproof layer be made of a cast latex rubber or other suitable rubber-type material, as it is a soft, pliable material that is also tolerant to scratching that may occur due to the animal and/or bite and tear resistance. This layer is preferably of increased thickness to provide the scratch, bite and tear resistance and therefore includes an engraved or recessed stitch line about the periphery thereof to simplify the stitch securement of the layers to the restraining strap. The breathable inner layer is preferably selected to minimize chafing of skin and hair around the area where the object is worn and to effectively isolate the nylon restraining strap from this portion of the pet. The ends of the exterior and interior layers are sewn and attached to the nylon restraining strap (see stitching 73 and 75). This restraining strap extends beyond these layers and includes a suitable arrangement for attachment to itself or other straps.

With this arrangement, all three components, namely the waterproof outer layer, the breathable inner layer, and the nylon restraining strap, move in an independent-type manner creating a breathable collar or harness that is also durable.

In the case of a dog collar, metal d-rings are used on both ends of a nylon restraining member to attach a separate nylon webbing loop that can be easily attached to a leash. This is a preferred form of the dog collar, but other arrangements can be used including the conventional dog collar with an adjustable securement clip or buckle arrangement.

Although various preferred embodiments of the present invention have been described herein in detail, it will be appreciated by those skilled in the art, that variations may be made thereto without departing from the spirit of the invention or the scope of the appended claims.

1. A pet restraint arrangement adapted to be worn by the pet comprising:
at least one elongate restraining strap of a material to provide sufficient tensile strength to restrain the pet and be secured about the neck or chest of the pet;
said elongate strap at an intermediate portion thereof is secured between an oversized waterproof layer located on one side of said elongate strap and an oversized breathable fabric layer provided on an opposite side of said elongate strap; and
wherein said breathable fabric covers said waterproof member and is peripherally attached to the waterproof layer on opposite sides of said elongate strap.

2. A pet restraint arrangement as claimed in claim 1 wherein said waterproof layer and said breathable fabric layer are attached to said at least one strap at either end of layers with the strap within said layers being free to move between said layers.

3. A pet restraint arrangement as claimed in claim 2 wherein said waterproof layer is of a latex material.

4. A pet restraint arrangement as claimed in claim 3 wherein said latex material is sewn to said breathable layer to thereby attach said breathable layer to said latex layer.

5. A pet restraint arrangement as claimed in claim 4 wherein said latex layer has an engraved peripheral recess in a top face thereof and a series of stitches are located in said recess to thereby secure said latex layer to said breathable fabric layer.

6. A pet restraint arrangement as claimed in claim 5 wherein said restraint arrangement is a dog collar with said breathable fabric layer providing a friction reducing surface between said elongate strap and the pet.

7. A pet restraint arrangement as claimed in claim 6 wherein said dog collar is a martingale style dog collar.

8. A pet restraint arrangement as claimed in claim 7 wherein said waterproof layer and said breathable layer form a sheath about said elongate strap;
said elongate strap beyond said sheath including, at either end thereof, a slip ring with a further restraint strap passing through both slip rings and secured to form a closed loop.

9. A pet restraint arrangement as claimed in claim 8 wherein said further restraint strap includes a fixed securement ring on an outer portion of said closed loop and intermediary said slip rings.

10. A pet restraint arrangement as claimed in claim 5 wherein said restraint arrangement is a pet harness.

11. A pet restraint arrangement as claimed in claim 10 wherein said elongate strap is a chest strap of said pet harness and said waterproof layer and said fabric layer extends to and is connected to a rear body strap of said harness.

12. A pet restraint arrangement as claimed in claim 1 wherein said latex waterproof material is of a rubber material having phosphorescent particles therein for glowing in the dark when appropriately activated.
